(19) United States
(12) Patent Application Publication
(10) Pub. No.: US 2017/0002177 A1
(43) Pub. Date: Jan. 5, 2017

(54) UV-STABILIZED POLYSULFONES-V4

(71) Applicant: SABIC GLOBAL TECHNOLOGIES B.V., Bergen op Zoom (NL)

(72) Inventors: ADITYA NARAYANAN, Santa Clara, CA (US); KAPIL CHANDRAKANT SHETH, Evansville, IN (US); FENG CAO, Loudonville, NY (US)

(73) Assignee: SABIC GLOBAL TECHNOLOGIES B.V., Bergen op Zoom (NL)

(21) Appl. No.: 14/755,371

(22) Filed: Jun. 30, 2015

(51) Int. Cl. C08K 5/3417; C08K 5/3437; C08K 3/26; C08K 3/22; C08K 3/30; C08K 3/16; C08K 5/3492; C08K 7/14

(52) U.S. Cl. CPC C08K 5/3417; C08K 5/3492; C08K 5/3437; C08K 7/14; C08K 3/22; C08K 3/30; C08K 3/16; C08K 3/26; C08K 2003/2241; C08K 2003/2296; C08K 2003/3045; C08K 2003/3036; C08K 2003/162; C08K 2003/265

(57) ABSTRACT

Compositions including a polysulfone and a UVA stabilizer. The polysulfone may be polysulfone (PSU), polyethersulfone (PES), polyphenylsulfone (PPSU) and mixtures thereof. The UVA stabilizer may include a benzotriazole moiety, a 1,3,5-triazine moiety, and/or a benzoxazinone moiety.

### BACKGROUND OF THE INVENTION

1. Field of the Invention

The invention relates generally to polysulfones and more specifically to UV-stabilized polysulfones.

2. Description of the Related Art

High heat thermoplastics such as ULTEM® polyetherimide (PEI) resins are known as outstanding high performance materials. ULTEM® resin (PEI) has a high glass transition temperature (Tg) of 217 degrees Celsius. Other materials comprising polysulfones have very good impact strength, and excellent chemical resistance to a wider range of chemicals and have lower color (yellowness index) than ULTEM® and can potentially be colored to lighter colors or shades than PEI resins making them attractive for applications in the consumer electronics industry. For example, polysulfone (PSU) has a heat distortion temperature (HDT) of about 174 degrees Celsius; polyethersulfone (PES) has an HDT of about 204 degrees Celsius; and polyphenylsulfone (PPSU) has an HDT of about 207 degrees Celsius. Unfortunately, polysulfones have poor UV resistance owing to their absorption in the ultra-violet (UV) wavelength region of from about 200 to 400 nm. When exposed to relatively high-power UV energy for short duration or low-power UV energy for longer duration, polysulfones show a dramatic increase in their yellowness rendering them unsuitable for applications requiring weathering resistance especially under natural or light colors, such as, for example a white color.

There is a long felt need for a polymeric blend that utilizes at least one polysulfone, such as PSU, PES, and/or PPSU, as a major component. Such a polysulfone could be blended with other polymers, such as polyetherimide (PEI) commercially available as ULTEM® brand PEI, to yield a composition having good chemical resistance. However, both polysulfones and PEI may yellow upon ultraviolet (UV) exposure. This reduces the desirability of these polymers and their blends as materials whose use would normally encounter short term high UV, or long term low UV, exposure. Although a common approach to reducing yellowing in polysulfones or PEI is to include an ultraviolet stabilizer (UVA), the common loading of UVA is low, on the order of less than 0.5-1.0% by weight. Not many UVA's can survive under the harsh processing conditions for these polymers (600-700 degrees Fahrenheit) and be effective. These constraints leave the long felt need for a polymeric blend that utilizes at least one polysulfone, such as PSU, PES, and/or PPSU, as a major component unsatisfied.

### BRIEF SUMMARY OF THE INVENTION

Disclosed herein are novel ultraviolet stabilizers (UVAs) independently formulated into the polysulfones or polysulfone/PEI blends. These UVAs can help reduce the yellowing or in other terms improve the weathering resistance of polysulfones, polysulfones/PEI blends after exposure to UV light per ASTM D4459 protocol (300 hrs.). Various embodiments relate to novel polysulfones (PSU, PES, PPSU) and their PEI blends, with a high loading (on the order of greater than 1% by weight) of an ultraviolet stabilizer. The resultant polymers have a wide range of uses where UV exposure is common, e.g., case components for “smart” cellular telephones, GPS (Global Positioning Devices), bicycle components, automobile trim and antennae covers, and products generally exposed to UV radiation. Polysulfones (PSU, PES, PPSU) and their blends with PEI are disclosed herein that have improved UV stability performance. Multiple UVAs were tested on these polysulfones and polysulfone/PEI blend materials using test protocol ASTM D4459 test for 300 hours exposure. Significant improvement in UV performance was achieved using certain UVAs in these polymers. Suitable UVAs are molecules containing at least one functional group whose structures are illustrated below:

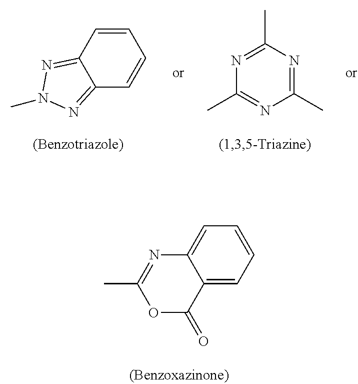

### DETAILED DESCRIPTION OF THE INVENTION

The present invention may be understood more readily by reference to the following detailed description of preferred embodiments of the invention, as well as to the examples included therein. All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

The invention is further described in the following illustrative examples in which all parts and percentages are by weight unless otherwise indicated.

Various embodiments relate to a composition including a polysulfone and a UVA stabilizer. The polysulfone may be selected from polysulfone (PSU), polyethersulfone (PES), and/or polyphenylsulfone (PPSU). Combinations and mixtures of these polysufones may be employed. The polysulfone may be present in an amount within a range having a lower limit and/or an upper limit. The range can include or exclude the lower limit and/or the upper limit. The lower limit and/or upper limit can be selected from about 5-99 parts by weight. For example, according to certain preferred embodiments, the polysulfone may be present in an amount up to 92 parts by weight. The polysulphones may also be blended with other polymers. The composition may include at least one UVA stabilizer. The UVA stabilizer may include a benzotriazole moiety, a 1,3,5-triazine moiety, and/or a benzoxazinone moiety. For example, the UVA stabilizer may include a moiety selected from:

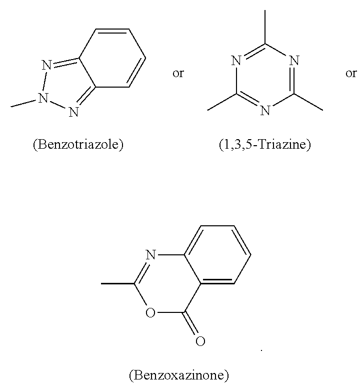

Mixtures and combinations of such UVA stabilizers may be employed. Any UVA stabilizer may include one or more such moieties. Some specific, non-limiting examples of suitable UVA stabilizers include ((2-(2′Hydroxy-5-T-Octylphenyl)-Benzotriazole)), (2-(4,6-Diphenyl-1,3,5-triazin-2-yl)-5-hexyloxyphenol), (2,2′-Methylene bis[4-(1,1,3,3-tetramethylbutyl)-6-(2H-benzotriazol-2-yl)phenol]), 2,2′-(1,4-Phenylene)bis(4H-3,1-benzoxazin-4-one, (Phenol, 2-(2H-benzotriazol-2-yl)-4,6-bis(1-methyl-1-phenylethyl), Tinuvin 1600, and mixtures thereof.

The UVA stabilizer may be present and added in an amount within a range having a lower limit and/or an upper limit. The range can include or exclude the lower limit and/or the upper limit. The lower limit and/or upper limit can be selected from about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10.0 parts, 11.0 parts, 12.0 parts, 13.0 parts 14.0 parts and 15.0 parts by weight, based on the total composition. For example, according to certain preferred embodiments, the UVA stabilizer may be present and added in an amount of up to 15 parts by weight, based on the total composition. According to other preferred embodiments, the UVA stabilizer may be present and added in an amount greater than 0.1 parts by weight, based on the total composition.

A variety of products may be formed from any composition disclosed herein, including but not limited to extruded or mold products. After processing, such as blending, extrusion, or molding, it is possible for the amount of UVA stabilizer initially added to change. According to various embodiments, after processing the composition by at least one of blending, extrusion, molding and combinations thereof, the UVA stabilizer present, may be present in an amount within a range having a lower limit and/or an upper limit. The range can include or exclude the lower limit and/or the upper limit. The lower limit and/or upper limit can be selected from about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10.0 parts, 11.0 parts, 12.0 parts, 13.0 parts, 14.0 parts and 15.0 parts by weight. For example, according to certain preferred embodiments, after processing the composition by at least one of blending, extrusion, molding and combinations thereof, the UVA stabilizer present, may be present in an amount of at least 0.1 parts by weight. Ensuring that the UVA stabilizer is present in these amounts after processing can impart beneficial properties to the processed composition.

Similarly, after processing, such as blending, extrusion, or molding, it is possible for the amount of UVA stabilizer initially added to change. According to various embodiments, after processing the composition by at least one of blending, extrusion, molding and combinations thereof, the UVA stabilizer present, may be present in an amount within a range having a lower limit and/or an upper limit. The range can include or exclude the lower limit and/or the upper limit. The lower limit and/or upper limit can be selected from about 5, 10, 15, 20, 25, 30, 35, 40, 45, 50, 55, 60, 65, 70, 75, 80, 85, 90, 95, 99, 100 percent by weight. For example, according to certain preferred embodiments, the UVA stabilizer may be present after processing the composition by at least one of blending, extrusion, molding and combinations thereof, in an amount that is at least 20% by weight of an initial loading of the UVA stabilizer.

The composition may further include one or more fillers and/or pigments.

The fillers may include, but are not limited to, glass fibers, carbon materials and combinations thereof. The pigments may include, but are not limited to, the group of pigments imparting a light color and pigments imparting a dark color. As used herein, the term “light color” means a pigment that imparts a color having L* value greater than 50 units. As used herein, the term “dark color” means a pigment that imparts a color having L* value less than 50 units.

According to various embodiments, the pigment may be any white pigment, such as TiO₂, ZnS, ZnO, BaSO₄, CaCl₂, CaCO₃, and compositions comprising TiO₂, and/or ZnS, and/or ZnO, and/or BaSO₄, and/or CaCl₂, and/or CaCO₃. The pigment may be present in an amount greater than 0.001 pph, greater than 0.01 pph, or greater than 0.1 pph.

An exemplary embodiment relates to a composition comprising a 92 parts by weight of a polysulfone and greater than 0.1 parts by weight of a UVA stabilizer. The polysulfone may be selected from polysulfone (PSU), polyethersulfone (PESU), polyphenylsulfone (PPSU) and mixtures thereof. The composition may also include a pigment in an amount up to 50 pph, (parts per hundred) based on 100 parts of the total polysulfone composition excluding colorant components. The composition may optionally include a filler.

### EXAMPLES

### Materials

Various polymers were employed in these examples. As used herein, “PSU” refers to polysulfone. As used herein, “PES” refers to polyethersulfone. As used herein, “PPSU” refers to polyphenylsulfone. As used herein PEI refers to polyetherimide. The ULTEM® brand polyetherimide (PEI) resins are commercially available from Saudi Basic Industries Corp, Plasticslaan 1, Bergen Op Zoom, The Netherlands.

Various ultraviolet stabilizers (UVA) were employed in these examples. As used herein, “UVA-1” refers to 2-(2′Hydroxy-5-T-Octylphenyl)-Benzotriazole with CAS 3147-75-9. As used herein, “UVA-2” refers to (2-(4,6-Diphenyl-1,3,5-triazin-2-yl)-5-hexyloxyphenol) with CAS 147315-50-2.

As used herein, “UVA-3” refers to (2,2′-Methylene bis[4-(1,1,3,3-tetramethylbutyl)-6-(2H-benzotriazole-2-yl)phenol]) with CAS 103597-45-1. As used herein, “UVA-4” refers to (2,2′-(1,4-Phenylene)bis(4H-3,1-benzoxazin-4-one) with CAS 18600-59-4. Their chemical structures are shown below.

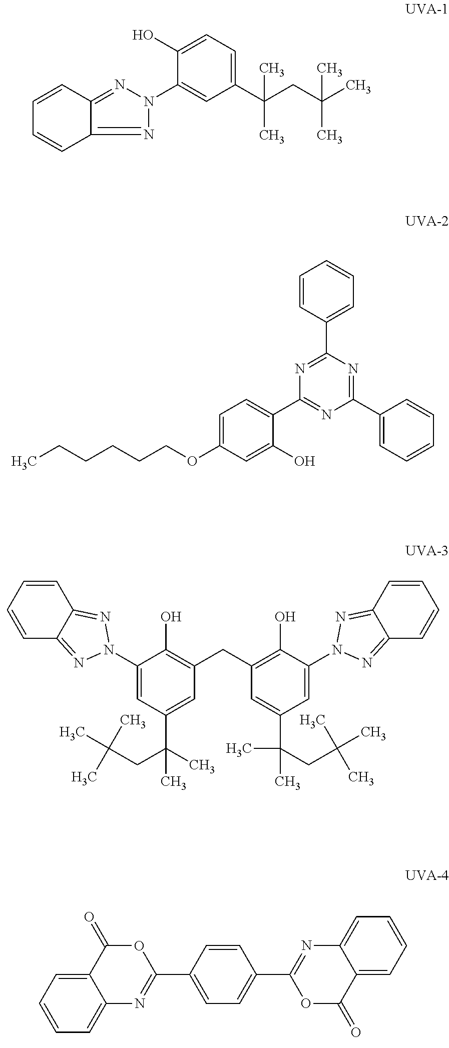

Various white pigments were employed in these examples. As used herein, white pigment refers to TiO₂.

A comprehensive set of experiments was conducted using PSU, PES and PPSU as the primary polymer resins, alone or blended with PEI and novel UVAs were independently formulated in each of the above resins and colored in white using TiO₂ pigment. Tables 1 through 3 show the Compositions 1 to 5 using PSU with process conditions and testing results. Tables 4 through 6 show the Compositions 6 to 10 using PES with process conditions and testing results. Tables 7 through 9 show the Compositions 11 to 15 using PPSU with process conditions and testing results. In each case, the UVA was dry blended with the polymer resin, and then extruded into pellets and molded into 2″×3″ chips at 0.1″ thickness prior to testing. UVA loadings were formulated at 8 parts by weight. Tables 10 and 11 show the Compositions 16 to 27 using PSU or PES or PPSU blended with PEI. UVA loading were at 4 pph (parts-per-hundred resin blend).

### Methods for Mixing Composition to Evaluate Compositions Space

In each example, the resin and colorants components were dry blended. The blend was extruded into pellets using WP30 co-rotating twin-screw extruder 300 rpm, feed-rate adjusted for each batch and temperature settings systematically varied from at 550-670 degrees Fahrenheit die temperature depending on the type of polysulfone as shown in the tables below.

### Methods for Molding Articles for Color, Weathering Evaluation

In each example, injection molding was performed on a 180-Ton DEMAG machine. The pellets were dried at 300° F. for minimum 4 hours prior to molding. The oil-heated mold was set 275-300° F. and a flat barrel temperature profile was set between 560-680° F. depending on type of polysulfone extruded pellets per batch. Injection speed was set at −1 inch/sec and screw speed at 75 RPM.

### Test Procedures for Color

Color measurements were performed on injection molded 2″×3″ color plaque at 0.1″ thickness using i7 spectrophotometer made by X-Rite under measurement conditions of CWF lighting, 10 degree observer CIE 94 standard, both UV and specular component included (SCI) mode.

UV weathering test was performed according to ATSM D4459 and the color shift of DE* was the difference of between color plaques before and after exposure (300 hours) and measured by i7 spectrophotometer.

### Examples 1-5

In Tables 1-3, Composition 1 is a comparative example which contains PSU compounded with 13 pph of white pigment TiO₂ and does not contain any UVA. Compositions 2 to 5 are inventive examples, each of which contains PSU, 13 pph (parts per hundred of the blend of resin plus UVA) white pigment TiO₂ and 8 parts by weight of different UVAs as shown in Table 1.

TABLE 1

| | Type | | | | | | | | | |
|---|---|---|---|---|---|---|---|---|---|---|
| | Comparative | | Inventive | | Inventive | | Inventive | | Inventive | |
| Example | 1 | | 2 | | 3 | | 4 | | 5 | |
| PSU | 100 | parts | 92 | parts | 92 | parts | 92 | parts | 92 | parts |
| UVA-1 | — | | 8 | parts | — | | — | | — | |
| UVA-2 | — | | — | | 8 | parts | — | | — | |
| UVA-3 | — | | — | | — | | 8 | parts | — | |
| UVA-4 | — | | — | | — | | — | | 8 | parts |
| TiO₂ | 13 | pph | 13 | pph | 13 | pph | 13 | pph | 13 | pph |

TABLE 2

| | Type | | | | |
|---|---|---|---|---|---|
| | Comparative | Inventive | Inventive | Inventive | Inventive |
| Example | 1 | 2 | 3 | 4 | 5 |
| Extrusion Temp (° F.) | 650 | 650 | 650 | 650 | 650 |
| Extrusion rpm | 300 | 300 | 300 | 300 | 300 |
| Drying temp. (° F.) | 300 | 300 | 300 | 300 | 300 |
| Drying time, hour | 6 | 6 | 6 | 6 | 6 |
| Barrel Temp. Profile, | 660 | 660 | 660 | 660 | 660 |
| (° F.) | | | | | |
| Mold Temp., (° F.) | 275 | 275 | 275 | 275 | 275 |

TABLE 3

| | Type | | | | |
|---|---|---|---|---|---|
| | Comparative | Inventive | Inventive | Inventive | Inventive |
| Example | 1 | 2 | 3 | 4 | 5 |
| UVA retention in | — | 3.50% | 5.80% | 5.70% | 6.00% |
| molded part per GPC | | | | | |
| analysis | | | | | |
| UVA % retention | | 49.4% | 81.9% | 80.5% | 84.7% |
| relative to initial | | | | | |
| loading | | | | | |
| DE* after 300 hrs UV | 18.4 | 8.1 | 9.8 | 4.9 | 8.2 |
| exposure per ASTM | | | | | |
| D4459 | | | | | |
| % Improvement | | 55.9% | 46.7% | 73.4% | 55.4% |

An important result reported in Table 3 is the % retention of the UVA in the molded part which is an estimate of how much UVA remains in the compounded material after blending, extrusion and molding. This is important because an UVA will not provide UV protection unless a sufficient amount remains in the final molded part after blending, extrusion and molding. In general, UVAs are small molecules and volatile compounds. Their typical loading is less than 1%. Depending on the process conditions, methods and temperatures it is possible that UVA can escape through vents, or as volatilized gas or decomposed otherwise during extrusion and molding process. As a result, certain UVAs are insufficient left in compounded material after processing and, thus, found ineffective in UV protection. Hence, proper selection and loading of UVAs to ensure their sufficient retention after processing are critical in order to realize the best possible UV weathering resistance of polymer.

As shown in the Table 3 for Compositions 2 to 5, the percent retention of each UVA is measured by GPC. It can be seen that in the case of Compositions 2 to 5, the percent retention of UVA was found to be just 3.5%, 5.8%, 5.7% and 6.0% versus the 7.08% (weight/weight) that was initially formulated in the respective compositions. Therefore, their percentage retention after processing was 49.4%, 81.9%, 80.5% and 84.7% respectively.

The GPC analysis on UVA retention was performed according the method described hereafter. The polymeric resin is dissolved in dichloromethane at a concentration of 2 mg/ml. The solution is then filtered through a 0.45 μm PTFE syringe filter into a sample vial for LC analysis. The UV additive content is measured on an Agilent Technologies 1100 liquid chromatograph equipped with diode array detector. The chromatograph is operated in size exclusion mode using a set of 2 Agilent Technologies PLGel Mixed-D columns (300 mm L×7.5 mm ID). The chromatograph is operated isocratically with dichloromethane at a flow rate of 1.0 ml/min. An external calibration curve is generated by analyzing a series of standard solution of the UV additive of interest in dichloromethane at known concentration levels. The UV additive content for the resin sample is determined from the calibration curve using both the signal area for the peak of interest at 325 nm and the overall sample concentration.

Composition 1, which is the control sample of PSU with no UVA, showed a DE* color shift of 18.4 units after 300 hours UV exposure per ASTM D4459 protocol. In comparison, the Inventive Composition 2 containing UVA-1 showed a much reduced DE* shift of 8.1 units, representing a 55.9% improvement versus the weathering of the control Composition 1 which contains no UVA. Similarly, the Inventive Composition 3 containing UVA-2 showed a much reduced DE* shift of 9.8 units, representing a 46.7% improvement versus the weathering of the control Composition 1 which contains no UVA. Similarly, the Inventive Composition 4 containing UVA-3 showed a much reduced DE* shift of 4.9 units, representing a 73.4% improvement versus the weathering of the control Composition 1 which contains no UVA. Similarly, the Inventive Composition 5 containing UVA-4 showed a much reduced DE* shift of 8.2 units, representing a 55.4% improvement versus the weathering of the control Composition 1 which contains no UVA. Therefore, in relative comparison, the Inventive composition 4 showed the best UV weathering improvement among the inventive examples, versus the control composition 1.

### Examples 6-10

In Tables 4, 5, and 6, Composition 6 is a comparative example, which contains PES compounded with 13 pph of white pigment TiO₂, and does not contain any UVA. Compositions 7 to 10 are inventive examples, each of which contain PES, 13 pph white pigment TiO₂ and 8 parts by weight of different UVAs as shown in Table 4.

TABLE 4

| | Type | | | | | | | | | |
|---|---|---|---|---|---|---|---|---|---|---|
| | Comparative | | Inventive | | Failure | | Inventive | | Inventive | |
| Example | 6 | | 7 | | 8 | | 9 | | 10 | |
| PES | 100 | parts | 92 | parts | 92 | parts | 92 | parts | 92 | parts |
| UVA-1 | — | | 8 | parts | — | | — | | — | |
| UVA-2 | — | | — | | 8 | parts | — | | — | |
| UVA-3 | — | | — | | — | | 8 | parts | — | |
| UVA-4 | — | | — | | — | | — | | 8 | parts |
| TiO₂ | 13 | pph | 13 | pph | 13 | pph | 13 | pph | 13 | pph |

TABLE 5

| | Type | | | | |
|---|---|---|---|---|---|
| | Comparative | Inventive | Failure | Inventive | Inventive |
| Example | 6 | 7 | 8 | 9 | 10 |
| Extrusion Temp (° F.) | 660 | 660 | 660 | 660 | 660 |
| Extrusion rpm | 300 | 300 | 300 | 300 | 300 |
| Drying temp. (° F.) | 300 | 300 | 300 | 300 | 300 |
| Drying time, hour | 6 | 6 | 6 | 6 | 6 |
| Barrel Temp. Profile, | 670 | 670 | 670 | 670 | 670 |
| (° F.) | | | | | |
| Mold Temp., (° F.) | 275 | 275 | 275 | 275 | 275 |

TABLE 6

| | Type | | | | |
|---|---|---|---|---|---|
| | Comparative | Inventive | Failure | Inventive | Inventive |
| Example | 6 | 7 | 8 | 9 | 10 |
| UVA retention in | — | 2.30% | 5.70% | 4.30% | 7.04% |
| molded part per GPC | | | | | |
| analysis | | | | | |
| UVA % retention | | 32.5% | 80.5% | 60.7% | 99.8% |
| relative to initial | | | | | |
| loading | | | | | |
| DE* after 300 hrs UV | 11.7 | 4.9 | 15.7 | 3.4 | 7.9 |
| exposure per ASTM | | | | | |
| D4459 | | | | | |
| % Improvement | | 58.1% | −34.2% | 70.9% | 32.4% |

As shown in Table 6 for Compositions 7 to 10, the percent retention of each UVA is measured by GPC. It can be seen that in the case of Compositions 7 to 10, the percent retention of UVA was found to be just 2.3%, 5.7%, 4.3% and 7.0% versus the 7.08% (weight/weight) that was initially compounded in the respective compositions. Therefore, their percentage retention after processing was 32.5%, 80.5%, 60.7% and 99.8% respectively.

Composition 6, which is the control sample of PES with no UVA, showed a DE* color shift of 11.7 units after 300 hours UV exposure per ASTM D4459 protocol. In comparison, the Inventive Composition 7 containing UVA-1 showed a much reduced DE* shift of 4.9 units, representing a 58.1% improvement versus the weathering of the control Composition 7 which contains no UVA. Similarly, the Inventive Composition 9 containing UVA-3 showed a much reduced DE* shift of 3.4 units, representing a 70.9% improvement versus the weathering of the control Composition 7 which contains no UVA. Similarly, the Inventive Composition 10 containing UVA-4 showed a much reduced DE* shift of 7.9 units, representing a 32.4% improvement versus the weathering of the control Composition 7 which contains no UVA. In contrast, the Composition 8 is a failure example containing UVA-2 showed an increase in DE* shift of 15.7 units, representing a 34% decrease in performance versus the weathering of the control Composition 7 which contains no UVA. It is possible that the UVA-2 in Composition 8 degraded during the processing of PES or does not perform efficiently with the PES system. It is to be recalled, however, that the UVA-2 shows very good weathering improvement in the PSU system shown previously in Tables 1-3 and also the PPSU system shown later in Tables 7-9. Therefore, in relative comparison, the Inventive composition 9 showed the best UV weathering improvement among the inventive examples, compared to the control composition 1

### Examples 11-15

In Table 7, 8, and 9, Composition 11 is a comparative example which contains PPSU compounded with 13 pph of white pigment TiO₂ and does not contain any UVA. Compositions 12 to 15 are inventive examples, each of which contain PPSU, 13 pph white pigment TiO₂ and 8 parts by weight of different UVAs as shown in Table 7.

TABLE 7

| | Type | | | | | | | | | |
|---|---|---|---|---|---|---|---|---|---|---|
| | Comparative | | Inventive | | Inventive | | Inventive | | Inventive | |
| Example | 11 | | 12 | | 13 | | 14 | | 15 | |
| PPSU | 100 | parts | 92 | parts | 92 | parts | 92 | parts | 92 | parts |
| UVA-1 | — | | 8 | parts | — | | — | | — | |
| UVA-2 | — | | — | | 8 | parts | — | | — | |
| UVA-3 | — | | — | | — | | 8 | parts | — | |
| UVA-4 | — | | — | | — | | — | | 8 | parts |
| TiO₂ | 13 | pph | 13 | pph | 13 | pph | 13 | pph | 13 | pph |

TABLE 8

| | Type | | | | |
|---|---|---|---|---|---|
| | Comparative | Inventive | Inventive | Inventive | Inventive |
| Example | 11 | 12 | 13 | 14 | 15 |
| Extrusion Temp (° F.) | 670 | 670 | 670 | 670 | 670 |
| Extrusion rpm) | 300 | 300 | 300 | 300 | 300 |
| Drying temp. (° F.) | 325 | 325 | 325 | 325 | 325 |
| Drying time, hour | 6 | 6 | 6 | 6 | 6 |
| Barrel Temp. Profile, | 680 | 680 | 680 | 680 | 680 |
| (° F.) | | | | | |
| Mold Temp., (° F.) | 275 | 275 | 275 | 275 | 275 |

TABLE 9

| | Type | | | | |
|---|---|---|---|---|---|
| | Comparative | Inventive | Inventive | Inventive | Inventive |
| Example | 11 | 12 | 13 | 14 | 15 |
| UVA retention in | — | 2.80% | 5.80% | 6.80% | 4.80% |
| molded part per GPC | | | | | |
| analysis | | | | | |
| UVA % retention | | 39.5% | 81.9% | 85.9% | 67.8% |
| relative to initial | | | | | |
| loading | | | | | |
| DE* after 300 hrs UV | 42.8 | 36.2 | 33.3 | 25.2 | 36.0 |
| exposure per ASTM | | | | | |
| D4459 | | | | | |
| % Improvement | | 15.4% | 22.2% | 41.1% | 15.9% |

As shown in the Table 9, for Compositions 12 to 15 the percent retention of each UVA is measured by GPC. It can be seen that in the case of Compositions 12 to 15, the percent retention of UVA was found to be just 2.8%, 5.8%, 4.8% and 6.8% versus the 7.08% (weight/weight) that was initially compounded in the respective compositions. Therefore, their percentage retention after processing was 39.0%, 81.9%, 85.9% and 67.8% respectively.

PPSU is known to have the worst weathering performance under UV exposure versus other polysulfones such as PSU and PES. Composition 11, which is the control sample of PPSU with no UVA, showed a drastic DE* color shift of 42.8 units after 300 hrs UV exposure per ASTM D4459 protocol. In comparison, the Inventive Composition 12, containing UVA-1, showed a reduced DE* shift of 36.2 units, representing a 15.4% improvement versus the weathering of the control Composition 11, which contains no UVA. Similarly, the Inventive Composition 13 containing UVA-2 showed a reduced DE* shift of 33.3 units, representing a 22.2% improvement versus the weathering of the control Composition 11, which contains no UVA. Similarly, the Inventive Composition 14 containing UVA-3 showed a much reduced DE* shift of 25.2 units, representing a 41.1% improvement versus the weathering of the control Composition 11 which contains no UVA. Similarly, the Inventive Composition 15 containing UVA-4 showed a reduced DE* shift of 36.0 units, representing a 15.9% improvement versus the weathering of the control Composition 11 which contains no UVA. Therefore, in relative comparison, the Inventive composition 14 showed the best UV weathering improvement among the inventive examples, versus the control composition 11.

### Examples 16-27

Example 16 through 27 demonstrate the effect of a UV stabilizer to reduce color shift after 300 hours exposure per ASTM D4459 protocol. Results are shown in Tables 10 and 11. Components (parts as unit) were dry blended. The blend was extruded into pellets using WP30 co-rotating twin-screw extruder 300 rpm, feed-rate adjusted for each batch and temperature settings systematically varied from at 550-570 degrees Fahrenheit (288-299 degrees Celsius) die temperature depending on polymer composition. The pellets were molded after drying at 250 degrees Fahrenheit (116 degrees Celsius) for at least 4 hours. Injection molding was done on a 180-Ton DEMAG machine. The oil-heated molder was set 220-250 degrees Fahrenheit (104-121 degrees Celsius) and a flat barrel temperature profile was set between 560-570 degrees Fahrenheit (293-299 degrees Celsius) depending on the polymer composition of the extruded pellets per batch. The injection speed was set at about 1 inch/sec (2.5 cm/second) and screw speed at 75 rpm.

As indicated in Tables 10 and 11, PC—Si refers to a polydimethylsiloxane-bisphenol A copolymer, having 6 mol % siloxane, an average block length of 40-50 units, a molecular weight (Mw) 23,000 g/mol (determined via GPC using polycarbonate standards), manufactured by interfacial polymerization. The polydimethysiloxane is available from SABIC®.

As indicated in the Tables 10 and 11, PC-ITR-Si refers to polydimethylsiloxane from SABIC®-ITR (Isophthalic acid-terephthalic acid-resorcinol)-bisphenol-A copolyestercarbonate copolymer, having an ester content of 83 mol %, a siloxane content of 1 wt % with an average siloxane chain length of about 10, prepared by interfacial polymerization, having a molecular weight (Mw) of about 24,500 g/mol, and being para-cumyl phenol end-capped.

As indicated in the Tables 10 and 11, Phosphite refers to a phosphite stabilizer.

TABLE 10

| | Comp | Invent | Invent | Comp | Invent | Invent |
|---|---|---|---|---|---|---|
| Components | 16 | 17 | 18 | 19 | 20 | 21 |
| PEI | 25.00 | 25.00 | 25.00 | 15.00 | 15.00 | 15.00 |
| PC-Si | 58.00 | 58.00 | 58.00 | 58.00 | 58.00 | 58.00 |
| PC-ITR-Si | 16.90 | 16.90 | 16.90 | 17.00 | 17.00 | 17.00 |
| Phosphite | 0.10 | 0.10 | 0.10 | 0.10 | 0.10 | 0.10 |
| PPSU | | | | 10.00 | 10.00 | 10.00 |
| PES | | | | | | |
| PSU | | | | | | |
| UVS-3 | | 4.00 | | | 4.00 | |
| UVS-4 | | | 4.00 | | | 4.00 |
| DE* after 300 | 11.6 | 3.9 | 3.9 | 17.7 | 4.3 | 10.1 |
| hrs UV | | | | | | |
| exposure | | | | | | |
| per D4459 | | | | | | |
| % | | 66.4% | 66.4% | | 75.7% | 42.9% |
| Improvement | | | | | | |

TABLE 11

| | Comp | Invent | Invent | Comp | Invent | Invent |
|---|---|---|---|---|---|---|
| Components | 22 | 23 | 24 | 25 | 26 | 27 |
| PEI | 15.00 | 15.00 | 15.00 | 15.00 | 15.00 | 15.00 |
| PC-Si | 58.00 | 58.00 | 58.00 | 58.00 | 58.00 | 58.00 |
| PC-ITR-Si | 17.00 | 17.00 | 17.00 | 17.00 | 17.00 | 17.00 |
| Phosphite | 0.10 | 0.10 | 0.10 | 0.10 | 0.10 | 0.10 |
| PPSU | | | | | | |
| PES | 10.00 | 10.00 | 10.00 | | | |
| PSU | | | | 10.00 | 10.00 | 10.00 |
| UVS-3 | | 4.00 | | | 4.00 | |
| UVS-4 | | | 4.00 | | | 4.00 |
| DE* after 300 | 14.7 | 3.8 | 4.1 | 14.4 | 3.9 | 4.2 |
| hrs UV | | | | | | |
| exposure | | | | | | |
| per D4459 | | | | | | |
| % | | 74.1% | 72.1% | | 72.9% | 70.8% |
| Improvement | | | | | | |

As shown in comparative example 16, a PEI blend with PC, shows that it has color shift of DE* after 300 hrs at 11.6 units. When a UV stabilizer is used (Invent 17 and 18), DE* is reduced to 3.9 and 3.9 units respectively, a 66.4% improvement. When a polysulfone is included in formulation (See: comparative example 19, 22 and 25), DE* is increased to 17.4, 14.7 and 14.4 respectively after 300 hrs exposure from 11.6 (Comparative example 16). However, when a UV stabilizer is used, DE* is reduced to 4.3 and 10.1 (Invent 20 and 21) from 17.7 of the Comparative example 19, an improvement of 75.5% and 42.9% respectively in the case of PPSU, reduced to 3.8 and 4.1 (Invent 23 and 24) from 14.7 of the Comparative example 22, an improvement of 74.1% and 72.1% respectively in the case of PES and reduced to 3.9 and 4.2 (Invent 26 and 27) from 14.4 of the Comparative example 25, an improvement of 72.9% and 70.8% respectively in the case of PSU.

Although the present invention has been described in considerable detail with reference to certain preferred versions thereof, other versions are possible. Therefore, the spirit and scope of the appended claims should not be limited to the description of the preferred versions contained herein. All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

We claim:

1. A composition comprising:
at least one polysulfone selected from the group consisting of polysulfone (PSU), polyethersulfone (PES), polyphenylsulfone (PPSU) and mixtures thereof; and
at least one UVA stabilizer comprising a moiety selected from the group Consisting Of: 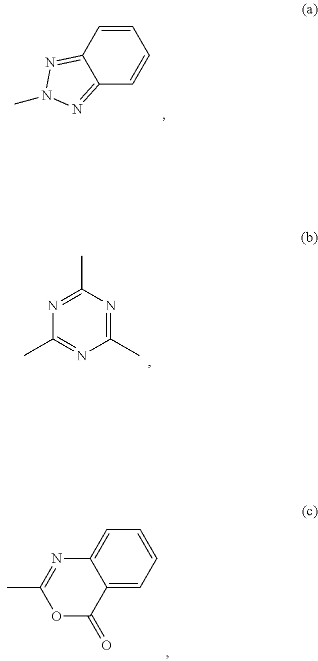
and combinations thereof.

2. The composition according to claim 1, wherein the UVA stabilizer present after processing the composition by at least one of blending, extrusion, molding and combinations thereof, is at least 20% by weight of an initial loading of the UVA stabilizer.

3. The composition according to claim 1, wherein the UVA stabilizer is selected from the group consisting of 2-(2′Hydroxy-5-T-Octylphenyl)-Benzotriazole, (2-(4,6-Diphenyl-1,3,5-triazin-2-yl)-5-hexyloxyphenol), (2,2′-Methylene bis[4-(1,1,3,3-tetramethylbutyl)-6-(2H-benzotriazole-2-yl)phenol]), 2,2′-(1,4-Phenylene)bis(4H-3,1-benzoxazin-4-one, (Phenol, 2-(2H-benzotriazol-2-yl)-4,6-bis(1-methyl-1-phenylethyl), Tinuvin 1600, and mixtures thereof.

4. The composition according to claim 1, further comprising a filler.

5. The composition of claim 4, wherein the filler comprises glass fiber.

6. The composition of claim 4, wherein the filler comprises a carbon material.

7. The composition according to claim 1, further comprising a white pigment.

8. The composition according to claim 4, further comprising a pigment.

9. The composition according to claim 7, wherein the pigment is one selected from the group of pigment imparting a light color and pigments imparting a dark color.

10. The composition according to claim 7, wherein the pigment is one selected from the group consisting of TiO₂, ZnS, ZnO, BaSO₄, CaCl₂, CaCO₃ and mixtures thereof.

11. The composition according to claim 7, wherein the pigment is present in an amount greater than 0.001 pph.

12. The composition according to claim 1, wherein the UVA stabilizer is (Phenol, 2-(2H-benzotriazol-2-yl)-4,6-bis(1-methyl-1-phenylethyl).

13. The composition according to claim 1, wherein the UVA stabilizer is present and added in an amount of up to 15% by weight, based on the total composition.

14. The composition according to claim 13, wherein the UVA stabilizer is present and added in an amount greater than 0.5% by weight, based on the total composition.

15. The composition according to claim 13, wherein the UVA stabilizer present after processing the composition by at least one of blending, extrusion, molding and combinations thereof, is at least 0.5% by weight.

16. An extruded product formed from the composition of claim 1.

17. An extruded product formed from the composition of claim 12.

18. A molded product formed from the composition of claim 1.

19. A molded product formed from the composition of claim 12.

20. An extruded product formed from the composition of claim 15.

21. A molded product formed from the composition of claim 15.

22. A composition comprising a polysulfone and a UVA stabilizer, the composition comprising;
a. at least one polysulfone selected from the group consisting of polysulfone (PSU), polyethersulfone (PESU), polyphenylsulfone (PPSU) and mixtures thereof in an amount up to 99% by weight;
b. a UVA stabilizer comprising (Phenol, 2-(2H-benzotriazol-2-yl)-4,6-bis(1-methyl-1-phenylethylethyl) in an amount greater than 0.5% by weight;
c. a pigment in an amount up to 30 pph, based on the weight of components a. and b.; and,
d. optionally a filler.
